(19) United States
(12) Patent Application Publication
(10) Pub. No.: US 2011/0321163 A1
(43) Pub. Date: Dec. 29, 2011

(54) PLATFORM FOR A COMPUTER NETWORK

(76) Inventor: Vincent Garnier, Bourg en Bresse (FR)

(21) Appl. No.: 13/121,349

(22) PCT Filed: Sep. 22, 2009
(86) PCT No.: PCT/FR2009/051779

§ 371 Date: Sep. 15, 2011

(30) Foreign Application Priority Data
Sep. 26, 2008 (FR) 08/05305

(51) Int. Cl. G06F 21/24; G06F 11/00; G06F 12/14; H04L 29/06

(52) U.S. Cl. 726/24; 726/26

(57) ABSTRACT

A platform for a computer network for managing and sharing mostly unstructured data passing through said network, and having an infrastructure including an information system having a database and/or data servers, as well as terminals from which the users generate, modify or consult data of the information system, where the information system includes unique data to be shared and is insulated from the terminals of the users by an application that manages the accessibility to said information system and/or the security of the unique data contained by the same by a physical disconnection of the network protocol used for communication between the information system and the terminals of the users.

### TECHNICAL FIELD

The present invention relates to a platform for a computer network whereof the infrastructure includes an information system including servers and mostly unstructured databases passing through said network, as well as terminals from which users generate, modify or consult centralized data from this information system. Each document of the information system is identified by its file name and passes through the network and is stored in this same information system in data form. In computers, data is a representation of information in a conventional form intended to make it easier to process.

### BACKGROUND

Currently, according to the Gartner Group, 85% of a business's information system in the broad sense (industrial or commercial business, but also administration, other public services, organization, etc.) is found in its unstructured data. Among other things it includes all email, text, audio and video files. One problem that arises lies in the fact that this data tends to double in volume every month, thereby taking up the majority of a business's network and storage resources. A same piece of data can also have several different origins and is then duplicated in the business's information system over several users' work stations. This duplication in turn introduces problems with identifying and securing the right files. Indeed, duplicating data is counter to a good security policy relative thereto and increases the chances of interception through a network.

At this time, there are three major communication computer network models:
the Internet, international communication network between different entities that are generally remote, such as computers, cameras, printers, servers, and using a communication protocol as language to communicate,
the intranet, network internal to a business, which operates on the Internet technological model, and
the extranet, zone of an intranet with restricted access, but accessible from outside the business on the condition the user has a user name and password.

Today, to secure the data passing through the network according to one of these three models, the user is restricted to his work station by assigning him rights. The work station or computer is most often a terminal, i.e. a communication center at the end of the network line able to exchange information with a server center. This restrictive model as well as the complexity and evolution of today's information systems make it increasingly difficult to secure the data passing through one of these networks. Paradoxically, and even though some applications no longer need to be recognized by the operating system to be able to be installed and operational, the general security of the information systems depends more and more on the work station and its operating system. Users even have more and more technical keys to open access doors, even though they are often not aware of the security and confidentiality stakes that result from their actions. Examples include mobile applications that allow a third party to access a private network completely discretely without that having been authorized, thereby giving the third party a chance to access the database of the information system.

Moreover, the tools currently available, such as proxies, firewalls, or the use of encrypting technologies theoretically designed to deal with these possibilities, and which are supposed to effectively secure access to the data of the information system being exchanged between users, require a substantial investment in the security of a business's or individual's data without, however, offering effective protection. Indeed, these tools do not ensure a physical disconnection of the communication protocol between the database and the users.

The primary job of a firewall is to control the traffic between different trust areas by filtering the flows of data that pass through there. It works according to rules established beforehand by the network administrator only.

A proxy relays requests between a client post and a server post. Concretely, the user identifies himself with a user name and password, then according to the rules, which again are determined in advance by the network administrator only, the user does or does not pass a firewall that filters communications depending on the port used. The ports can be likened to doors associated with a service or a network application and providing or not providing access to the client machine's operating system in a client/server model, i.e. providing or not providing access to the users' terminals as well as the data they contain. A number is assigned to each port, this number being coded on 16 bits, which explains why there is a maximum of 65,536 (2¹⁶) ports per computer.

Security problems can then arise when certain programs “forget” to close these ports, or even simply when the poorly mastered configuration of a computer allows the ports to be opened without any utility. This gives rise to breaches of computer security, because if a port is not closed, anyone can use it and access the database of the local information system. For example, a computer pirate generally uses a computer program that sends requests to a target machine by scanning all of its ports until it finds an entry port allowing it to access the machine's local information system.

As for encrypting technologies, all they do is encode the information using a pre-established algorithm. One therefore need only acquire the algorithm to decode the information.

It should be noted that even though most people do not have the knowledge required to perform this type of illegal act, this same majority also does not have the skills needed to correctly and effectively use a firewall or a proxy, the parameterization of which has become too complex. The evolution of current security systems has therefore not followed the opening of computing to the “general public.”

The present invention adopts a new vision of the computer network that, instead of being based on the user's work station controlling the user's actions by assigning rights, is based on access to the data grouped together within a central information system, which makes it much easier to protect. A single document is thus created by a user, who files it in the centralized information system. He then assigns usage rights for that document to other users. To that end it is possible to introduce the concept of document publication to define the provision of a document generated by one of the users.

There are thus two types of users:
users simply viewing the published information,
contributors, who have the right to create and/or modify the information.

Some commercial products have already tried such an approach of grouping data together and making it available, for example the products registered under the Microsoft© SharePoint™ commercial mark, or IBM© Lotus® QuickR™. However, the development of these solutions is focused more towards sharing data within a restricted network, often the company's intranet, than global sharing and data security. As an illustration, one need only see that these solutions always depend on the work station on which they must be installed to operate and do not insulate access to the information system's data by users via a physical disconnection of the communication protocol. Moreover, the overall security policy on these platforms is quite often limited to the use of simple firewalls, proxies, or encrypting technologies.

### BRIEF SUMMARY

The present invention aims to propose a solution resolving these drawbacks without, however, damaging the quality of service.

To that end, the present invention essentially relates to a computer network platform for managing and sharing mostly unstructured data passing through said network, and having an infrastructure comprising an information system comprising one or more databases and/or data servers, as well as terminals from which the users generate, modify or consult data of the information system, characterized in that the information system includes unique data to be shared and is insulated from the terminals of the users by an application that manages the accessibility to said information system and/or the security of the unique data contained by the same by a physical disconnection of the network protocol used for communication between the information system and the terminals of the users.

This computer network platform makes it possible to centralize unique data, in particular the unstructured data of a business that normally takes up a large amount of space on the business's servers due to scattering and duplication. “Unique data” refers to data that has not been previously duplicated and that is present in the information system, for example in the form of a unique document. The security policy for the data is therefore based here on the data itself and not only on its transfer through one or more computer networks. This computer network platform also allows secure and easy access to said data by also leaving aside a three-dimensional architecture formed by the three existing network models and makes it possible to reframe all of the security around the data. To that end, the application could be qualified as “dynamic proxy” because it does not include pre-established security rules, but on the contrary security rules established on request for each document contained in the information system. This causes a simplification of the architectures owing to this application inserted between the database of the information system and the terminals of the users wishing to access it.

In the continuation of the description, it is assumed that the communication network uses the TCP/IP protocol, i.e. it is based on TCP (Transmission Control Protocol) and IP (Internet Protocol). The invention is clearly not limited to these particular types of communication protocols.

In one embodiment, the physical disconnection of the network protocol is managed by the application that controls two independent sub-applications that are physically separated from all network connections between them, concretely one of the sub-applications, called inside (I), is continuously connected to the inside network of the information system, and the other sub-application, called outside (E), is continuously connected with the so-called outside network to which all of the users' terminals are connected.

In one embodiment, the passage of data between the two sub-applications that is managed by the application uses the “parsing” technique.

When the application takes the information from (E) to deposit it in (I), the information becomes “dead” and not accessible outside the application. If, despite everything, a virus were to remain attached to the document, it would take on the same status as the “inactive” document.

In one embodiment, the publication of the documents contained in the information system is independent of the software or programs installed on the terminals of the users.

This gives the software independence from the work station for increased user efficiency, and in particular makes it possible for users having different software on their work station and the formats of which are not usually compatible with each other, to work on a same document having a different file format on each of their machines. Here again, the platform does away with the content from the work station of the users' terminals. Several users can therefore work and modify a same document published by a contributor, without those users all having, on their respective work stations, the software used to create the document in a particular file format.

In one embodiment, the terminals of the users are only used for their graphic interface and their computation capacity, the unique data only being stored in the information system.

This centralization of the data in the information system in particular makes it possible to prevent a same document from being found on several work stations with different versions and dates without it being known which is actually the right document. This measure is also in complete compliance with the desired level of security for this type of platform.

It does, however, remain possible to extract a document from the information system through the application if the rights specific to that action have been assigned to the concerned user. However, for security reasons that fall under the very principle of that platform, the extracted document may not be escalated towards the information system's database without permission.

According to another embodiment, the information system does not contain work stations.

Access to the information system's database is therefore only done through the application, direct access not being possible.

In one embodiment, the application is also the only means of directly accessing the unique data stored in the information system. This unique data generates a unique document. The application is therefore the only one that can manage the content of the information system.

Indeed, everything happens as if the documents were enclosed in a strong room containing a multitude of safes, and where the bank's strong room can only be accessed by a guard who can be compared to the application. The bank's address, as well as the key to one or several safes each located in the strong room, is given by one user to another with whom he wishes to share documents. Different colored keys are used to differentiate between the rights a user can claim. The manager of the bank, who can be likened to the application's administrator, gives the access codes (user name and password) for the entrance door to the bank to various users. Once inside, the guard (application) identifies each user: he asks them for the key to the safe of the strong room they have the right to access, identifies the rights of the user according to the color of the key provided, checks (by anti-virus), if needed, the documents contributed by a user to incorporate a safe in the strong room. This key can be provided on site in the case of a safe location, compared to an allocation of space in the information system. The guard (application) is the only one who can enter the strong room (information system), he then takes the user's key and goes to look for the content of the corresponding safe located in the strong room. The guard (application) can open the safe(s) (file(s)) for which the client has the key (rights) and only those safes. The guard (application) then brings the contents of the safes (files) out to the user. Depending on the color of the key provided, the guard assigns a right to modify the document or read-only rights. Once the user's task is complete, the guard (application) takes the document back, which he will check again (by anti-virus) before putting it back in its respective safe inside the strong room. The user then leaves the bank again with his key and that key can be taken from him at any time by the user who gave it to him. At no time may the user directly access the documents located inside the safes in the strong room.

In one embodiment, the protocols and/or services provided by the application are independent of the type of use, such as itinerant, mobile, from a fixed station, or in public areas.

Indeed, the platform can support all kinds of computer network techniques, such as wifi™ or 3G. It is understood that these examples are non-limiting and that the use of any other network technique is completely possible.

In one embodiment, the application only uses ports open by default by an operating system installed on the terminals, preferably only ports 80 for http (HyperText Transfer Protocol), 443 for HTTPS (HyperText Transfer Protocol Secured) and 21 for FTP (File Transfer Protocol).

Only these three ports are open on the application and the terminals can only use these ports on the URL (Uniform Resource Locator) address of the application. It is thus much simpler to set up the application because one need only open these three ports on all of the terminals to be able to communicate with the application. It should be noted that these three ports are open by default regardless of the operating system used on the work station of the users' terminals. The users will therefore be able to communicate with the application without difficulty while having other open ports necessary for other local applications.

In one embodiment, the information system contains at least one unique document for which the viewing and/or access and/or modification rights for/by each user are given by the user who created the document.

Everything therefore happens as if each contributor was “administrator” for the document he created. He is responsible for assigning viewing and modification rights for the document that he will publish in the information system's database via the application. It is understood that the assignment of these rights is simple and intuitive, without which the desire for simplification would lose all meaning.

In another embodiment, the application manages a type of temporary storage, preferably FTP, created in the sub-application (E) during the command to transfer data from a terminal towards the application and/or during the creation of data directly from the application, and erased as soon as the data has reached the information system.

This temporary storage space can advantageously be made up of a FTP (File Transfer Protocol) cache, capable of warehousing large volumes of information; the application then takes the information contained in that FTP cache to deposit it in the information system by parsing it. The information is then only accessible from the application. It is thus protected from the rest of the network.

In one embodiment, the temporary storage space is monitored by at least one anti-virus program, but preferably two.

This makes it possible to reduce the likelihood of infection of the database in the information system. This check is done systematically when a contributor conveys data towards the temporary storage space of the application, but of course this in no way prevents users from checking data themselves that is located on their work station using their own anti-virus software.

According to one embodiment, the application comprises a graphic interface.

This interface replaces the operating system, is user-friendly, simple and intuitive, and does not require any particular training for the user.

In the context of this embodiment, the graphic interface of the application of the platform assumes the form of a universal secured data sharing solution with a workspace that is preferably multilingual and accessible from any one of the terminals of the users throughout the world and connected to the application.

Unlike the cited products of the prior art, it is not necessary here to install any software needed for the operation of the application. Moreover, the graphic interface is provided to be multilingual for easier access from any point in the world, and it is multi-server, multi-base, multi-site, and multi-address book to facilitate the assignment of rights. This platform is therefore universal and easily accessible to all potential users.

In one embodiment, an internet browser serves as operating system for the graphic interface.

It is therefore sufficient, to access the universal sharing solution of the application, to have a simple Internet connection, an Internet browser, and to have the URL address for the application that will be provided to all network users. A shortcut can advantageously be created in the explorer.

The present invention also relates to an assembly comprising a plurality of platforms interconnectable with each other and with an infrastructure as described above.

Several same users can thus access several different information systems via several independent or non-independent applications; such a platform therefore perfectly replaces the three major existing computer network models mentioned before by covering them according to a single model without, however, doing away with them.

### BRIEF DESCRIPTION OF THE FIGURES

The invention will be better understood in light of the following description, in reference to the appended diagrammatic drawings showing, as a non-limiting example, one embodiment of this platform.

FIG. 1 shows the synoptic diagram of the platform.

FIG. 2 shows an example of an application of that platform.

### DETAILED DESCRIPTION

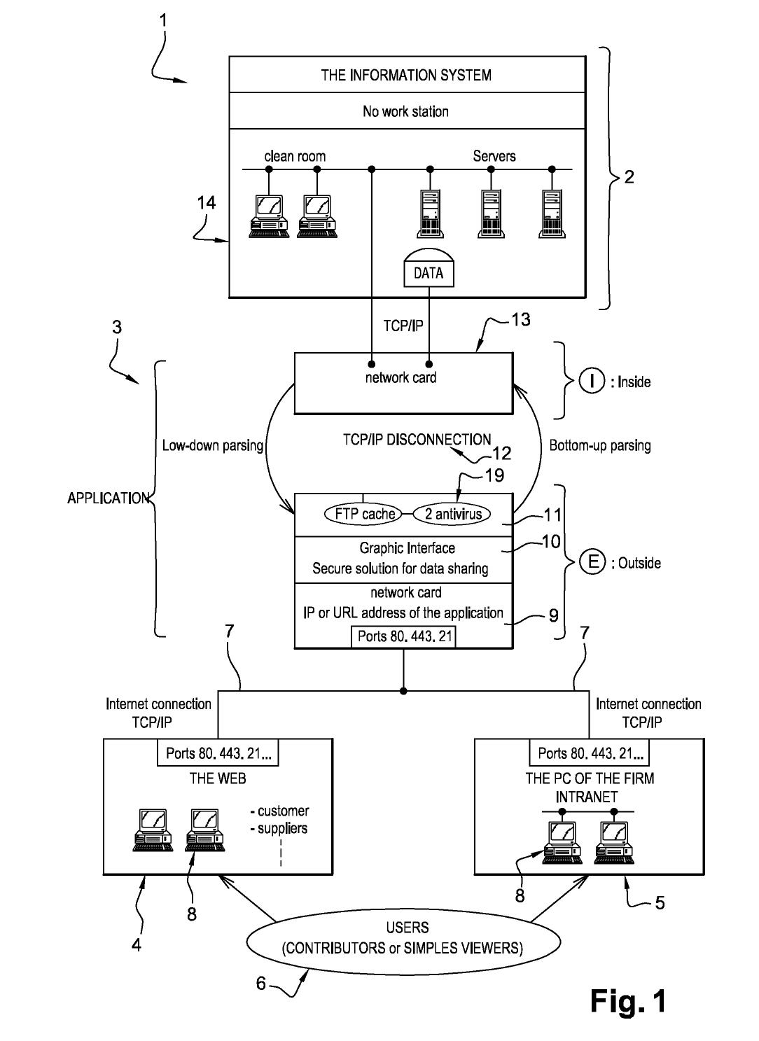

According to the synoptic flowchart of the platform shown in FIG. 1, one can see that the users 6 (contributors or simple viewers) can indifferently connect to the application 3 from the web 4 (World Wide Web) or from the company's intranet network 5, which has an Internet connection 7 using the TCP/IP protocols. Each of the work stations 8 of those two networks is open on ports 80, 443 and 21.

These work stations 8 are connected via Internet and its TCP/IP protocols to the application 3 and more particularly to the outside sub-application (E), which comprises a network card 9 allowing it to communicate with the outside, a FTP cache 11 making it possible to temporarily store data that can take up a large volume, and the universal sharing solution serving as graphic interface 10 for the application 3.

The outside sub-application (E) is physically separated from the inside sub-application (I) by a disconnection 12 of the TCP/IP protocols.

The inside sub-application (I) comprises one or several network cards 13 that allow it to communicate according to the TCP/IP protocols with the set of storage resources 14 of the information system 2 via their respective network cards.

The information system 2 therefore contains all of the storage resources 14 of the information system 2; these comprise databases (DATA), and/or individual local servers or those grouped together in a computer clean room. However, it does not contain work stations.

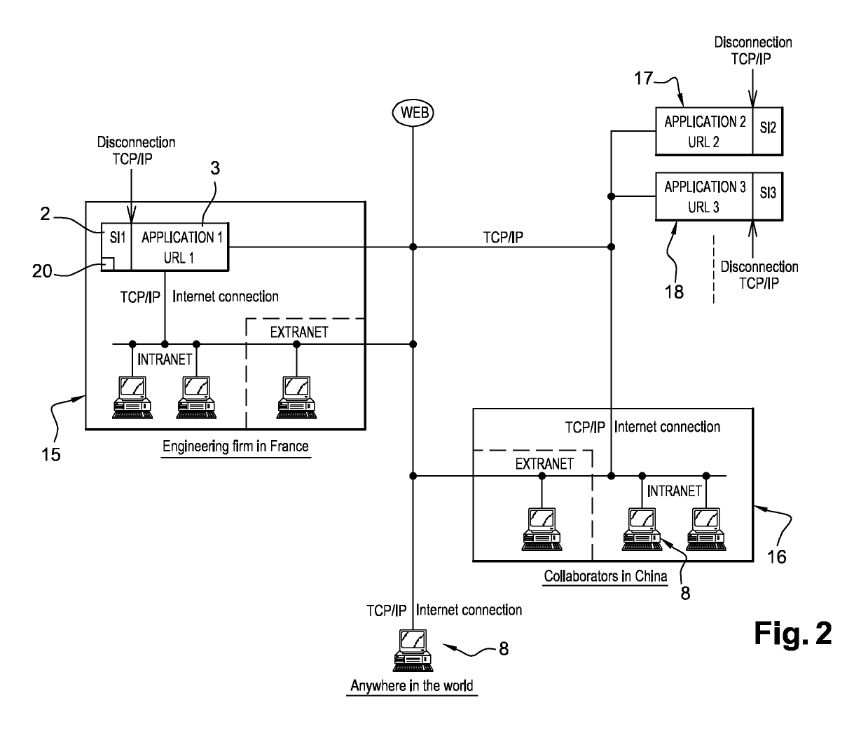

We will now consider the concrete case illustrated in FIG. 2, where a contributor working from an engineering firm 15 in France wants to create a document 20, but above all wants to be able to then share it with his collaborators 16 in China without it being scattered in a multitude of files and while providing that they can modify it; the various modifications appearing in a unique final document 20 contained in the information system 2 managed by a same application 3.

First concerning the connection to the application 3, the contributor 6 has several possibilities:
the French contributor connects to the business's application 3 from the address bar of his Internet browser by entering the URL address of his business's hosting server or any other hosting server 17, 18 through which he wishes to share documents, for example the hosting server of the Chinese collaborators,
the French contributor connects to the application 3 through a hypertext link sent to him by his company on his email if he has activated that service,
the French contributor has been created as a contact in the address book of another user 6, the contributor wishing to share a document then receives an email informing him of this creation as well as a direct link to the application 3 for which it has been assigned.

Once connected, the contributor then accesses the home page of the graphic interface 10 of the application 3 offering him the universal sharing solution for the information in the document. The administrator for each application can then define the contexts of the application (graphic charters, layouts, page contents, translations, . . . ). The contributor then has the option of changing the language of the text of the graphic interface 10 as he wishes. In order to access the services of the application 3, he is asked for a user name and password unique to him and that are given to him by the administrator of the application 3 to which he is connected.

Concerning the creation of information in the system, here again the contributor has several options:
he directly creates a new document via the application 3 according to the information he wishes to share (text, spreadsheet, slide show . . . ). To that end, the great flexibility of the application 3 offers him a series of software applications from which he can define the format of his document. The document created is temporarily stored in the FTP cache 11 of the outside sub-application (E).
he imports, into the FTP cache 11, a pre-existing document locally through the explorer of his work station 8.

This FTP cache is continuously monitored by two anti-virus programs 19 managed by the application 3.

It is also important to note that when this type of platform 1 is set up for a business structure or any other structure, the solution provided by the application 3 is capable of massively incorporating a set of pre-existing data of the business.

The following step comprises sharing said document, the contributor assigns the usage rights to that document 20 to other users 6 listed in his address book, such as the Chinese collaborators or ones that he has created or imported into that same address book. He can then assign modification rights to certain users, while he only assigns read-only rights to others.

To share this document, he then needs only publish it in the information system 2 by pressing the “publish” button. The publication comprises transferring, by parsing, the information created in the FTP cache 11 of the sub-application (E) towards a storage area of the information system 2 by passing through the network card 13 of the sub-application (I). This arrangement ensures the physical disconnection 12 of the TCP/IP protocols 7 between the information system 2 and the various terminals 8 of the users. When the application 3 takes the information (E) to deposit it in (I), the information becomes “dead” and non-accessible outside the application 3, the FTP cache 11 is also cleaned by the application 3 when the application 3 takes the data (E) to deposit it in (I). The French contributor can then disconnect from the application 3. It should be noted that a published document 20 is only visible to the users 6 who have been authorized by the creator of the document 20.

To look for the document, the Chinese users 6 each connect from their work station 8 to the application 3 of the business in one of the same ways as for the contributor.

The user 6 then connects to his account using a user name and password assigned to him by the administrator of that application 3 of the business. Once connected, each user 6 sees the documents for which he has been given rights, and only those documents.

The names of the files and only the names appear on the screen and the graphic charter, adaptable according to the business's needs, directly shows, without needing to open it, the rights related to a document. The user 6 never points directly to the document contained in the database of the information system 2. Non-limitingly, the application 3 has, via its graphic interface 10, three presentation possibilities:
list form,
object form, and
name form.

The rights related to each of the files appearing under one of these three forms has a color code making it possible to indicate, immediately and visually, a user's rights to a file. Five distinct colors are preferably used in order to identify the different types of files among which one finds, classified hierarchically by decreasing order of power over the file:
“You are the creator of this document.”
“This document was published to you.”
“This document is currently being modified by another user. You can view it if the software allows.”
“Several people can open this document at once.”
“This document is read-only. You can view it.”

When the user 6 wants to open a document 20 for which he has rights, he clicks on a “publishing” button, i.e. for viewing the content of the document 20. It is then possible for this same document 20 to be modified at the same time by a contributor, in which case an information window on the status of the file opens. In this case, the users 6 see, through this information window, that the file corresponding to the document 20 is being modified and do not have the option of publishing the document 20.

It is therefore necessary to wait for a contributor to have finished his modifications to the document 20 and republished it in the information system 2 for another contributor to be able in turn to access that same document 20 in order to modify it himself. The file corresponding to the document 20 will thus be kept up to date by each of the contributors and all of the modifications made to that file will appear in a unique document 20 contained in the information system 2 managed by an application 3 shared by all users 6 of the file.

As goes without saying, the invention is not limited solely to the embodiment and application of this platform 1, described above as an example, but rather it encompasses all alternatives.

1. A computer network platform for managing and sharing mostly unstructured data passing through said network and whereof an infrastructure comprises:
an information system comprising one or more databases and/or data servers, and
terminals from which the users generate, modify or consult data of the information system,
wherein the information system:
includes unique data to be shared, and
is insulated from the terminals of the users by an application that manages accessibility to said information system and/or security of the unique data contained by the same by a physical disconnection of the network protocol used for communication between the information system and the terminals of the users.

2. The computer network platform according to claim 1, wherein the physical disconnection of the network protocol is managed by the application that controls two independent sub-applications that are physically separated from all network connections between them, concretely one of the sub-applications, called inside, is continuously connected to an inside network of the information system), and the other sub-application, called outside, is continuously connected with a so-called outside network to which all of the terminals of the user are connected.

3. The computer network platform according to claim 2, wherein the application manages a type of temporary storage, preferably FTP, created in the sub-application during the command to transfer data from a terminal towards the application and/or during the creation of data directly from the application, and erased as soon as the data has reached the information system.

4. The computer network platform according to claim 3, wherein the temporary storage space is monitored by at least one anti-virus program.

5. The computer network platform according to claim 2, wherein the passage of data between the two sub-applications that is managed by the application uses a parsing technique.

6. The computer network platform according to claim 1, wherein publication of the documents contained in the information system is independent of the software or programs installed on the terminals of the users.

7. The computer network platform according to claim 1, wherein the terminals of the users are only used for graphic interface and computation capacity, the unique data only being stored in the information system.

8. The computer network platform according to claim 1, wherein the information system does not contain work stations.

9. The computer network platform according to claim 1, wherein the application is the only means of directly accessing the unique data stored in the information system.

10. The computer network platform according to claim 1, wherein the protocols and/or services provided by the application are independent of the type of use, comprising itinerant, mobile, from a fixed station, or in public areas.

11. The computer network platform according to claim 1, wherein the application only uses ports open by default by an operating system installed on the terminals, comprising only ports 80 for HTTP, 443 for HTTPS, and 21 for FTP.

12. The computer network platform according to claim 1, wherein the information system contains at least one unique document for which viewing and/or access and/or modification rights for/by each user are given by the user who created the document.

13. The computer network platform according to claim 1, wherein the application comprises a graphic interface.

14. The computer network platform according to claim 13, wherein the graphic interface of the application of the platform assumes a form of a universal secured data sharing solution with a workspace that is preferably multilingual and accessible from any one of the terminals of the users connected to the application.

15. The computer network platform according to claim 14, wherein an internet browser serves as operating system for the graphic interface.

16. An assembly comprising a plurality of platforms interconnectable with each other and with an infrastructure according to claim 1.
